(19) United States
(12) Patent Application Publication
(10) Pub. No.: US 2023/0051713 A1
(43) Pub. Date: Feb. 16, 2023

(54) MULTIPLE-TASK NEURAL NETWORKS

(71) Applicant: Hewlett-Packard Development Company, L.P., Spring, TX (US)

(72) Inventors: Thomas da Silva Paula, Porto Alegre (BR); David Murphy, Palo Alto, CA (US); Wagston Tassoni Staehler, Porto Alegre (BR); Juliano Cardoso Vacaro, Porto Alegre (BR)

(73) Assignee: Hewlett-Packard Development Company, L.P., Spring, TX (US)

(21) Appl. No.: 17/793,666

(22) PCT Filed: Feb. 12, 2020
(86) PCT No.: PCT/US2020/017989

§ 371 Date: Jul. 19, 2022

(51) Int. Cl. G06N 3/08

(52) U.S. Cl. CPC G06N 3/08

(57) ABSTRACT

Examples of neural networks trained for multiple tasks are described herein. In some examples, a method may include determining a feature vector using a first portion of a neural network. In some examples, the neural network is trained for multiple tasks. Some examples of the method may include transmitting the feature vector to a remote device. In some examples, the remote device is to perform one of the multiple tasks using a second portion of the neural network.

### BACKGROUND

The use of electronic devices has expanded. Computing devices are a kind of electronic device that includes electronic circuitry for performing processing. As processing capabilities have expanded, computing devices have been utilized to perform more functions. For example, a variety of computing devices are used for work, communication, and entertainment. Computing devices may be linked to a network to facilitate communication between computing devices.

### BRIEF DESCRIPTION OF THE DRAWINGS

FIG. 1 is a flow diagram illustrating an example of a method for neural network execution;

FIG. 2 is a flow diagram illustrating an example of a method for neural network execution;

FIG. 3 is a block diagram of an example of an apparatus and remote devices that may be used in neural network execution;

FIG. 4 is a block diagram illustrating an example of a computer-readable medium for neural network execution; and

FIG. 5 is a block diagram illustrating an example of an apparatus and a remote device in accordance with some examples of the techniques described herein.

### DETAILED DESCRIPTION

Machine learning is a technique where a machine learning model is trained to perform a task or tasks based on a set of examples (e.g., data). In some examples, executing machine learning models may be computationally demanding for processors, such as central processing units (CPUs). Artificial neural networks are a kind of machine learning model that is structured with nodes, layers, and/or connections. Deep learning is a kind of machine learning that utilizes multiple layers. A deep neural network is a neural network that utilizes deep learning.

Some examples of deep learning utilize convolutional neural networks (CNNs). In some examples, CNNs may use powerful hardware for training and/or prediction. As used herein, the term “predict” and variations thereof may refer to determining and/or inferencing. For instance, an event or state may be “predicted” before, during, and/or after the event or state has occurred. In some examples, the training time for CNNs may be relatively high (e.g., may take days or weeks depending on the size of the network and the data). In some examples, prediction or inferencing time may be a constraint for some implementations. For instance, it may be beneficial to provide fast prediction for real-time or near real-time implementations. In some examples, graphics processing units (GPUs) may be utilized to provide fast prediction, while some central processing units (CPUs) may exhibit reduced performance for CNN processing. A GPU is hardware (e.g., circuitry) that performs arithmetic calculations. For example, a GPU may perform calculations related to graphics processing and/or rendering.

Some of the techniques described herein may enable some devices with less resources (e.g., less memory, less processing resources, etc.) to use a resource-intensive neural network. For example, some low-resource devices may be unable to process some resource-intensive neural networks within a target time without some examples of the techniques described herein. Some examples of the techniques described herein may be utilized to improve the performance of some relatively higher-resource devices (e.g., workstations, servers), which may allow lower power consumption for a task and/or may allow the execution of more tasks.

In some examples, the computational capabilities of a group of devices may be leveraged to perform neural network processing. For example, a variety of devices may be in communication with each other. For instance, personal assistants, mobile phones, embedded systems, laptops, workstations, and/or servers, etc., may be linked to (e.g., in communication with) a communication network or networks (e.g., local area network (LAN), wide area network (WAN), personal area network (PAN), etc.). Some of the techniques described herein may include splitting the computation of multiple-task neural networks over multiple devices. For example, a combination of a local device and a remote device or devices may be utilized to perform neural network processing.

Deep learning may be utilized to perform different tasks, such as image classification (e.g., environment classification), image captioning, object detection, object locating, object segmentation, regression, audio classification, sentiment analysis, text classification (e.g., spam email filtering), etc. In some examples, one input or one kind of input may be utilized to perform multiple tasks. For example, a neural network may be trained to classify an environment, segment objects, and to locate objects based on an image or images. In some examples, a neural network may be split over a group of devices, where portions of a neural network respective tasks may be distributed over a group of devices.

When splitting a neural network over devices, it may be beneficial to reduce communication overhead. In some examples of the techniques disclosed herein, a portion of a neural network may be processed locally in order to reduce an amount of communicated data. For example, a first portion of a neural network may utilize an image to produce a feature vector. A feature vector is a vector including features. A feature is data. For example, a feature may be data used by a neural network for training or inferencing. Examples of features may include data indicating image characteristics (e.g., lines, edges, corners, etc.), audio characteristics (e.g., pitch, amplitude, timing, etc.), text attributes (e.g., frequency of words in a passage), etc. Feature extraction may be a procedure used to determine and/or extract features (e.g., feature vector(s)) from data (e.g., image(s), audio, text, etc.). In some examples, the feature vector may be communicated to a remote device instead of the image, which may reduce an amount of communicated data. In some examples of the techniques described herein, an amount of feature vector change may be utilized to determine whether to send the feature vector. For instance, a threshold may be utilized to determine whether to send the feature vector based on the feature vector change, which may reduce an amount of communicated data.

In an example, an apparatus equipped with a GPU may execute an initial computation using a portion of a neural network, which may reduce the size of an image to a representation that is smaller than the image and faster to upload to a server than the image. In some examples, the server may store another portion or portions of the neural network and may include a GPU or GPUs, which may provide a faster computation time due to the parallelism and efficiency of the GPUs. Accordingly, some examples of the techniques described herein may be beneficial by enabling resource-constrained devices to utilize complex neural networks, by reducing an amount of communicated data, and/or by providing faster and/or more efficient neural network processing.

Throughout the drawings, identical reference numbers may designate similar, but not necessarily identical, elements. Similar numbers may indicate similar elements. When an element is referred to without a reference number, this may refer to the element generally, without necessary limitation to any particular drawing figure. The drawing figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

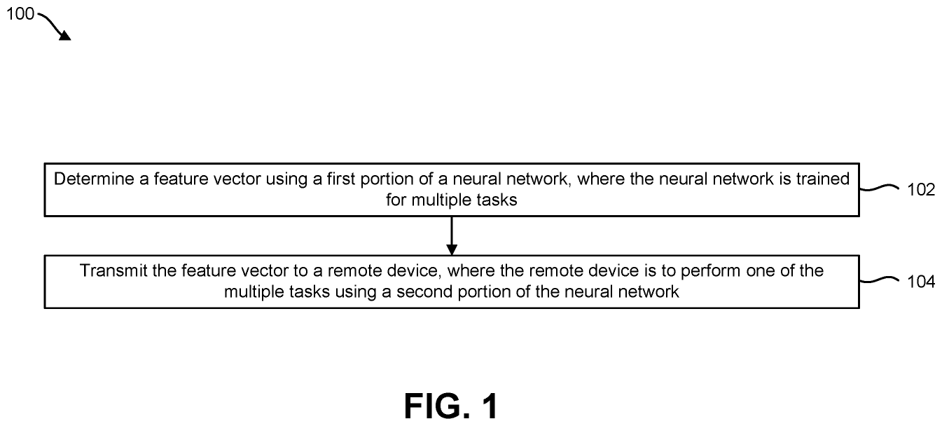

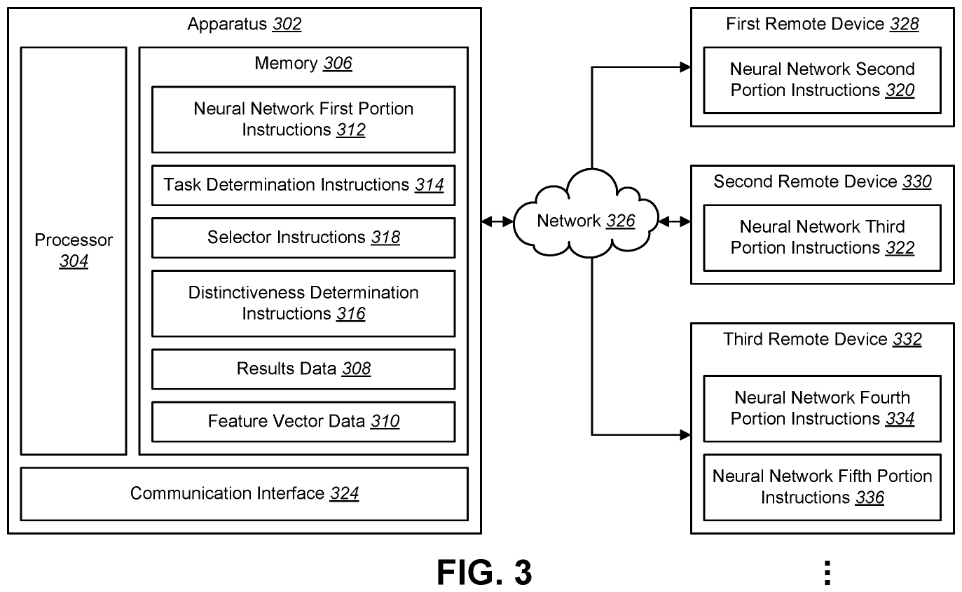

FIG. 1 is a flow diagram illustrating an example of a method 100 for neural network execution. The method 100 and/or a method 100 element or elements may be performed by an apparatus (e.g., electronic device, computing device, server, etc.). For example, the method 100 may be performed by the apparatus 302 described in connection with FIG. 3.

The apparatus may determine 102 a feature vector or feature vectors using a first portion of a neural network, where the neural network is trained for multiple tasks. For example, the neural network may be trained to perform multiple tasks such as image classification (e.g., environment classification), image captioning, object detection, object locating, object segmentation, audio classification, and/or sentiment analysis, etc. A portion of a neural network is a node or nodes of a neural network. In some examples, a portion of a neural network may include a layer or layers and/or a connection or connections. In some examples, the first portion of the neural network is stored in the apparatus (e.g., in memory of the apparatus). Other portions of the neural network may be distributed over a set of remote devices. For example, each other portion of the neural network (besides the first portion, for instance) may respectively correspond to each of the multiple tasks.

In some examples, the first portion of the neural network overlaps for each of the multiple tasks. For example, the first portion of the neural network may be jointly utilized for any of the multiple tasks, may be shared between multiple tasks, and/or may be a portion of the neural network that is in common to the multiple tasks. For instance, a feature vector that is produced by the first portion of the neural network may be utilized for any or all of the multiple tasks. In some examples, each of the multiple tasks may correspond to a mutually exclusive portion of the neural network relative to each of the other multiple tasks. In some examples, each portion of the neural network corresponding to one of the multiple tasks may include a node or nodes that is/are exclusive to the task (e.g., not included in another portion of the neural network for another task) and/or that does/do not overlap with another portion of the neural network for another task. In some examples, each task may correspond to a layer or layers that is/are unique to the task. In some examples, different portions of the neural network (besides the first portion, for instance) may be stored and/or executed on different remote devices. In some examples, the first portion of the neural network may be located on an edge device and other portions of the neural network may be located on a cloud device or devices (e.g., server(s)). In some examples, the first portion of the neural network may be located on a cloud device and other portions of the neural network may be located on an edge device or devices (e.g., devices on a local network). In some examples, an apparatus may utilize multiple application programming interfaces (APIs) to access portions of the neural network, where each API corresponds to a different task.

In some examples, the apparatus may determine 102 the feature vector by providing data to the first portion of the neural network and/or executing the neural network based on data. The first portion of the neural network may be trained to produce a feature vector based on the data. For example, the first portion of a neural network may produce a feature vector or feature vectors from a node or nodes (e.g., layer or layers) of the first portion of the neural network. In some examples, the first portion of the neural network may not produce a final inference based on the data. For example, the first portion of the neural network may not include an output node or nodes (e.g., output layer or layers) that produces a prediction or inference based on the data. For instance, the first portion of the neural network may detect edges, lines, corners, etc., in an image, but may not produce a prediction or inference indicating whether any object was detected in the image or how the image is classified, etc. In some examples, the first portion of the neural network may produce a feature vector or feature vectors that may be utilized by another portion of the neural network (that corresponds to a task, for instance) to produce a prediction or inference.

In some examples, determining 102 the feature vector may include obscuring data input to the first portion of the neural network. For example, the feature vector produced by the first portion of the neural network may not directly indicate the data input to the first portion of the neural network. Obscuring the data input to the first portion of the neural network may make the original data unable to be reconstructed based on the feature vector(s). For instance, it may be difficult or impossible to reconstruct original data based on the feature vector(s) without additional information. In some examples, obscuring the input data may protect user privacy by sending a feature vector or vectors instead of original input data. In some examples, the data input to the first portion of the neural network may be obscured by the first portion of the neural network. For example, the first portion of the neural network may transform and/or change the input data to produce a feature vector or feature vectors that do not clearly indicate the input data. For instance, the first portion of the neural network (e.g., node(s), layer(s), connection(s)) may perform an operation or operations on the input data such that the determined feature vector is formatted differently from the input data and/or has different meaning than the input data. In some examples, the input data may include image data (e.g., pixel data), and the first portion of the neural network may use the image data to produce a feature vector or vectors (e.g., a set of numeric values) that are different from the image data (e.g., pixel values).

The apparatus may transmit 104 the feature vector to a remote device, where the remote device is to perform one of the multiple tasks using a second portion of the neural network. For example, the apparatus may transmit 104 the feature vector(s) to a remote device or remote devices using a wired link, a wireless link, and/or a network or networks. A remote device may perform a task using a second portion of the neural network. For example, the remote device may utilize a node or nodes, a layer or layers, and/or a connection or connections to perform a prediction or inference based on the feature vector(s). In some examples, the remote device may transmit the prediction or inference to the apparatus.

In some examples, the apparatus may transmit 104 the feature vector to multiple remote devices, where each of the remote devices is to perform one of the multiple tasks using portions of the neural network. For example, the remote devices may perform different tasks concurrently (e.g., in overlapping time periods) using different portions of the neural network.

In some examples, the apparatus may select a remote device from a set of remote devices. The apparatus may transmit 104 the feature vector to the selected remote device. In some examples, the apparatus may select the remote device based on a task. For instance, each of the remote devices may be mapped to a task or tasks. The apparatus may select the remote device(s) corresponding to a target task or tasks (e.g., determine task(s)). For instance, a first remote device may include a portion of the neural network for performing an image classification task and a second remote device may include a portion of the neural network for performing an object detection task. In a case that a target task is image classification (e.g., to determine a type of room), the apparatus may transmit the feature vector to the first remote device. In a case that a target task is object detection (e.g., finding an object), the apparatus may transmit the feature vector to the second remote device. In a case that both tasks are target tasks, the apparatus may transmit the feature vector to the first remote device and to the second remote device. In some examples, the apparatus may store a mapping (e.g., look-up table, array, list, etc.) between the tasks and the remote devices. Accordingly, the apparatus may select the remote device(s) corresponding to the target task(s).

In some examples, the method 100 (or an operation or operations of the method 100) may be repeated over time. For example, determining 102 a feature vector and/or transmitting 104 the feature vector may be repeated periodically over time. In some examples, the apparatus may determine a sequence of feature vectors corresponding to a sequence of data. For example, the apparatus may determine a feature vector for each frame (e.g., image) in a sequence of frames (e.g., video). The apparatus may determine whether to transmit a next (e.g., subsequent) feature vector or feature vectors. In some examples, the determined 102 feature vector may correspond to first data (e.g., a first frame of audio, video, etc.), and the apparatus may determine a second feature vector corresponding to second data (e.g., a second frame of audio, video, etc.) using the first portion of the neural network. For instance, the first data may be a first frame and the second data may be a second frame in a frame sequence. The apparatus may determine whether to transmit the second feature vector.

In some examples, determining whether to transmit the second feature vector may include determining a distance between the feature vector and the second feature vector. Determining whether to transmit the second feature vector may include comparing the distance to a distance threshold. Between two consecutive frames from a camera, for example, the differences in a scene may be relatively small (e.g., an object removed, small object motions, etc.). Small changes in the image may result in small changes in the feature vector. The apparatus may compute the distance between the feature vector (that was transmitted 104, for example) and the second feature vector. For instance, the apparatus may determine (e.g., compute) a Euclidean distance between the feature vector and the second feature vector. The apparatus may compare the distance to a distance threshold. In a case that the distance satisfies the distance threshold (e.g., is greater than the distance threshold), the apparatus may transmit the second feature vector. In a case that the distance does not satisfy the distance threshold (e.g., is less than or equal to the distance threshold), the apparatus may not transmit the second feature vector. In some examples, the distance threshold may be settable and/or adjustable. For example, the distance threshold may be set based on a user input and/or based on experimentation. A cosine distance may be an example of the distance in some approaches. For instance, when using a cosine distance between two vectors, the distance may range between 0 and 1. Distances nearer to 1 may indicate less similar (or more dissimilar) vectors. Distances nearer to 0 may indicate more similar vectors. In some examples, a distance threshold may be 0.15, where distances less than or not more than 0.15 may be considered similar (where the feature vector may not be sent to the remote device, for instance). In some examples, distances that are larger than or at least 0.15 may be considered different (where the feature vector may be sent, for instance). Other examples of the distance threshold may be utilized (e.g., 0.1, 0.12, 0.18, 0.2, etc.).

In some examples, determining whether to transmit the second feature vector may be based on a nearest neighbor search and/or a trained classifier for comparing the feature vectors (e.g., feature vector and second feature vector. For example, the apparatus may perform a nearest neighbor search to determine a nearest neighbor distance between a second feature vector and previous feature vectors (e.g., a quantity of previous feature vectors). In some examples, the nearest neighbor distance may be compared to a distance threshold to determine whether to transmit the second feature vector. In some examples, the apparatus may determine whether to transmit the second feature vector using a trained classifier. For instance, the trained classifier may compare feature vectors. For example, the trained classifier may be a machine learning model that is trained to infer whether a feature vector has changed relative to a previous feature vector or feature vectors to a degree that a prediction or inference is to be updated.

In some examples, determining whether to transmit the second feature vector may include determining a change metric between each feature of the feature vector and a corresponding feature of the second feature vector. For instance, a first change metric may be determined between a first feature of the feature vector and a first feature of the second feature vector, a second change metric may be determined between a second feature of the feature vector and a second feature of the second feature vector, etc. Determining whether to transmit the second feature vector may include determining whether a change metric meets a change criterion. For instance, the change metric may be a percentage change (e.g., 10%, 15%, 20%, 0.05, 0.1, 0.3, etc.) between individual features. In some examples, the change criterion may be a change threshold. The apparatus may compare the change metric(s) to the change threshold. In a case that the change threshold is satisfied (e.g., a change metric is greater than the change metric), the apparatus may transmit the second feature vector. In a case that the change metric does not satisfy the change threshold (e.g., all of the change metrics are less than or equal to the change threshold), the apparatus may not transmit the second feature vector. In some examples, the apparatus may evaluate each of the individual features of the feature vectors to determine a degree of change between the individual features. The change criterion may be a settable and/or adjustable change threshold with respect to the degree of change between the feature vectors. In some examples, a change metric may be a statistical measure. For example, the apparatus may determine a running mean, standard deviation, and/or variance of individual features, percent change of features, and/or feature vectors over a period of time. The statistical measure may be utilized to determine whether a feature vector has changed to a degree over the period of time. For example, the apparatus may compare the statistical measure to a change criterion or threshold (e.g., 1 standard deviation, 0.5 standard deviation, etc.) that is based on the statistics over the period of time.

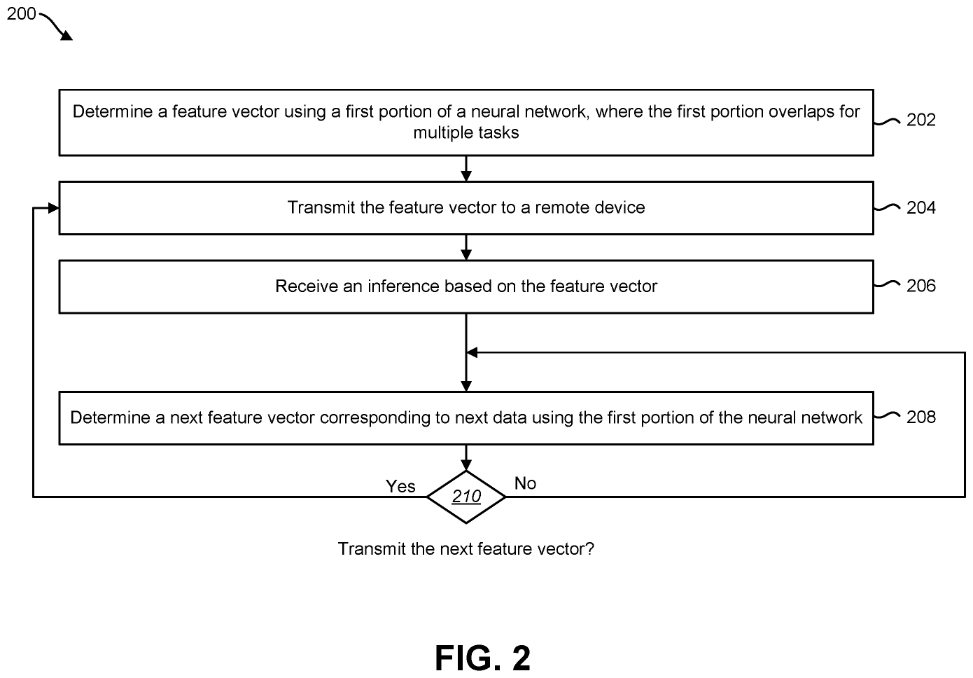

FIG. 2 is a flow diagram illustrating an example of a method 200 for neural network execution. The method 200 and/or a method 200 element or elements may be performed by an apparatus (e.g., electronic device, computing device, server, etc.). For example, the method 200 may be performed by the apparatus 302 described in connection with FIG. 3. In some examples, the method 200 or element(s) thereof described in connection with FIG. 2 may be an example of the method 100 or element(s) thereof described in connection with FIG. 1.

The apparatus may determine 202 a feature vector using a first portion of a neural network, where the first portion overlaps for multiple tasks. In some examples, determining 202 the feature vector may be performed as described in relation to FIG. 1.

The apparatus may transmit 204 the feature vector to a remote device. In some examples, transmitting 204 the feature vector may be performed as described in relation to FIG. 1.

The apparatus may receive 206 an inference based on the feature vector. For example, the remote device may determine the inference using another portion (e.g., a non-overlapping portion) of the neural network. For instance, the remote device may receive the feature vector from the apparatus and execute a portion of the neural network using the feature vector. The portion of the neural network may produce the inference. For example, the portion of the neural network may be trained to perform a task or tasks of the multiple tasks. The remote device may transmit the inference (or data indicating the inference, for example) to the apparatus. For example, the remote device may transmit the inference to the apparatus using a wired link, a wireless link, and/or a network or networks. The apparatus may receive 206 the inference from the remote device using a wired link, a wireless link, and/or a network or networks. For example, the apparatus may receive 206 the inference in response to transmitting 204 the feature vector to the remote device.

The apparatus may determine 208 a next feature vector corresponding to next data using the first portion of the neural network. In some examples, determining 208 the next feature vector may be performed as described in relation to FIG. 1. For example, the apparatus may utilize a sequence of data (e.g., a sequence of image frames, audio frames, etc.) to produce a sequence of feature vectors. For instance, the apparatus may determine 202 the feature vector based on a first frame and may determine 208 a next feature vector corresponding to a next frame in a frame sequence using the first portion of the neural network.

The apparatus may determine 210 whether to transmit the next feature vector. For example, determining 210 whether to transmit the next feature vector may be performed as described in relation to FIG. 1. In some examples, the apparatus may determine a distance between the feature vector and the next feature vector and compare the distance to a distance threshold. In some examples, the apparatus may determine a nearest neighbor distance and compare the nearest neighbor distance to the distance threshold. In some examples, the apparatus may utilize a trained classifier to compare the feature vectors, where the trained classifier may indicate whether or not to transmit the next feature vector. In some examples, the apparatus may determine a change metric based on an individual feature or individual features of the feature vector and may determine whether the change metric meets a change criterion (e.g., change threshold). In some examples, the apparatus may determine a statistical measure and compare the statistical measure to a change criterion or threshold.

In a case that it is determined 210 to transmit the next feature vector, the apparatus may transmit 204 the next feature vector to a remote device. In a case that it is determined 210 not to transmit the next feature vector, the apparatus may not transmit the feature vector (e.g., may discard the next feature vector) and may determine 208 a subsequent feature vector. In some examples, operation(s), function(s), and/or element(s) of the method 200 may be omitted and/or combined.

FIG. 3 is a block diagram of an example of an apparatus 302 and remote devices 328, 330, 332 that may be used in neural network execution. The apparatus 302 may be an electronic device, such as a personal computer, a server computer, a smartphone, a tablet computer, a personal assistant, a laptop computer, a game console, a smart appliance, a vehicle, a drone, aircraft, etc. The apparatus 302 may include and/or may be coupled to a processor 304 and/or a memory 306. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may be implemented to perform one, some, or all of the functions, operations, elements, etc., described in connection with one, some, or all of FIGS. 1-5.

The memory 306 may be any electronic, magnetic, optical, or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the apparatus 302 may include a communication interface 324 through which the processor 304 may communicate with an external device or devices (e.g., remote devices 328, 330, 332). In some examples, the apparatus 302 may be in communication with (e.g., coupled to, have a communication link with) a remote device or remote devices 328, 330, 332 via a network 326. Examples of the remote devices 328, 330, 332 may include computing devices, server computers, desktop computers, laptop computers, smart phones, tablet devices, game consoles, smart appliances, etc. Examples of the network 326 may include a local area network (LAN), wide area network (WAN), the Internet, cellular network, Long Term Evolution (LTE) network, 5G network, etc. In some examples, the apparatus 302 may be an edge device and the remote device(s) 328, 330, 332 may be cloud devices. In some examples, the apparatus 302 and the remote device(s) 328, 330, 332 may be edge devices (e.g., may be in communication via a LAN). In some examples, the apparatus 302 may be a cloud device and the remote device(s) 328, 330, 332 may be edge devices.

The communication interface 324 may include hardware and/or machine-readable instructions to enable the processor 304 to communicate with the remote devices 328, 330, 332. The communication interface 324 may enable a wired and/or wireless connection to the remote devices 328, 330, 332. In some examples, the communication interface 324 may include a network interface card and/or may also include hardware and/or machine-readable instructions to enable the processor 304 to communicate with the remote devices 328, 330, 332. In some examples, the communication interface 324 may include hardware (e.g., circuitry, ports, connectors, antennas, etc.) and/or machine-readable instructions to enable the processor 304 to communicate various input and/or output devices, such as a keyboard, a mouse, a display, another apparatus, electronic device, computing device, etc., through which a user may input instructions and/or data into the apparatus 302. In some examples, the apparatus 302 (e.g., processor 304) may utilize the communication interface 324 to send and/or receive information. For example, the apparatus 302 may utilize the communication interface 324 to send a feature vector or feature vectors and/or may utilize the communication interface 324 to receive a result or results. A result is an output or determination of a task or neural network. For example, a result may be an inference, a prediction, a value, etc., produced by a portion of neural network on a remote device.

In some examples, each remote device 328, 330, 332 may include a processor, memory, and/or communication interface (not shown in FIG. 3). In some examples, each of the memories of the remote devices 328, 330, 332 may be any electronic, magnetic, optical, or other physical storage device that contains or stores electronic information (e.g., instructions and/or data), such as, for example, Random Access Memory (RAM), Electrically Erasable Programmable Read-Only Memory (EEPROM), a storage device, an optical disc, and/or the like. In some examples, each of the processors of the remote devices 328, 330, 332 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in corresponding memory. In some examples, each communication interface of the remote devices 328, 330, 332 may include hardware and/or machine-readable instructions to enable the respective remote device 328, 330, 332 to communicate with the apparatus 302. Each of the remote devices 328, 330, 332 may have similar or different processing capabilities, memory capacities, and/or communication capabilities relative to each other and/or relative to the apparatus 302.

In some examples, the memory 306 of the apparatus 302 may store a neural network first portion instructions 312, task determination instructions 314, selector instructions 318, distinctiveness determination instructions 316, results data 308, and/or feature vector data 310.

The processor 304 may execute the neural network first portion instructions 312 to determine a first feature vector. For example, the processor 304 may determine a first feature vector using a first portion of a neural network. In some examples, determining the first feature vector may be performed as described in relation to FIG. 1 and/or FIG. 2. In some examples, the first feature vector may be stored as feature vector data 310.

The processor 304 may execute the task determination instructions 314 to determine, from multiple tasks, a task for the first feature vector. For example, the processor 304 may select a task or tasks from multiple tasks for the first feature vector. The multiple tasks may be tasks that the neural network is trained to perform. For example, portions of the neural network (besides the first portion, for instance) may each be trained to perform one of the multiple tasks. In some examples, the task determination instructions 314 may determine a task or tasks for the first feature vector based on a type of application running on the apparatus 302 (e.g., an application being executed by the processor 304). For instance, the application may indicate a target inference or task(s). For example, the processor 304 may utilize the task determination instructions 314 to determine an application that is running on the apparatus. For instance, the processor 304 may obtain a list of running applications and determine a task or tasks associated with the running applications and/or may receive or detect an event (e.g., a program call) for a task or tasks from a running application. In some examples, a camera application may indicate a facial detection task, an interior design application may indicate an image classification task, a transcription application may indicate a speech recognition task, an autonomous driving application may indicate an object detection (e.g., pedestrian, sign, obstacle, etc., detection) task and an image classification (e.g., city driving, highway driving, etc.) task, etc. The processor 304 may determine the task or tasks associated with the application(s) and/or called by the application(s).

The processor 304 may execute the selector instructions 318 to select a remote device corresponding to the determined task or tasks. In some examples, selecting a remote device may be performed as described in relation to FIG. 1. In the example illustrated in FIG. 3, a first remote device 328 includes neural network second portion instructions 320, a second remote device 330 includes neural network third portion instructions 322, and a third remote device includes neural network fourth portion instructions 334 and neural network fifth portion instructions 336. Each of the neural network portion instructions 320, 322, 334, 336 on the remote devices 328, 330, 332 may correspond to a task. The processor 304 may select a remote device or devices based on a correspondence or mapping between the determined task(s) and the neural network portion(s) and/or remote device(s). For instance, the processor 304 may look up which remote device and/or neural network portion corresponds to a determined task or tasks. The processor 304 may select the remote device(s) and/or neural network portion(s) corresponding to the task(s).

The apparatus 302 (e.g., processor 304) may send the first feature vector to the selected remote device, where the selected remote device is to perform the determined task using a portion of the neural network. In a case that the first remote device 328 is the selected remote device, for instance, the apparatus 302 (e.g., processor 304) may send the first feature vector to the first remote device 328, where the first remote device 328 is to perform the determined task using a second portion of the neural network. For example, the first remote device 328 may include a processor and memory, where the processor executes the neural network second portion instructions 320 stored in the memory to perform the determined task. In some examples, the first remote device 328 may send a result (e.g., inference, prediction) to the apparatus 302.

The apparatus 302 may receive a result or results (e.g., inference(s), prediction(s), etc.). In some examples, the apparatus 302 (e.g., processor 304) may utilize the communication interface 324 to receive the result. In some examples, the apparatus 302 (e.g., processor 304) may store the result as results data 308.

In some examples, the multiple tasks respectively correspond to remote portions of the neural network that are mutually exclusive from each other. For example, the remote portions of the neural network may be portions of the neural network that are remote from the first portion of the neural network on the apparatus 302 (e.g., that are stored on remote devices 328, 330, 332 separately from the first portion of the network stored on the apparatus 302). For instance, the remote portions of the neural network may include a second portion of the neural network on the first remote device 328, a third portion of the neural network on the second remote device 330, and a fourth portion of the neural network and a fifth portion of the neural network on the third remote device 332. The first remote device 328 may use the second portion of the neural network by executing the neural network second portion instructions 320, the second remote device 330 may use the third portion of the neural network by executing the neural network third portion instructions 322, and/or the third remote device 332 may use the fourth portion of the neural network by executing the neural network fourth portion instructions 334 and/or may use the fifth portion of the neural network by executing the neural network fifth portion instructions 336. The multiple tasks may be distributed over multiple remote devices. For example, the multiple tasks may be distributed over the remote devices 328, 330, 332. For instance, a task of the second portion of the neural network may be performed by the first remote device 328, a task of the third portion of the neural network may be performed by the second remote device 330, a task of the fourth portion of the neural network may be performed by the third remote device 332, and a task of the fifth portion of the neural network may be performed by the third remote device 332.

In some examples, the neural network operation (e.g., prediction, inferencing) may be performed in two parts. For example, the apparatus 302 (e.g., processor 304) may perform feature extraction to produce a feature vector or feature vectors. The feature vector(s) may be sent to a remote device or devices 328, 330, 332 and may be provided to different portions of the neural network, which may output different results depending on the tasks for which the portions were trained. The way in which the portions of the neural network are distributed or spread may be flexible. For example, a second portion of a neural network may be stored in the first remote device 328, a third portion of the neural network may be stored in the second remote device 330, and fourth and fifth portions of the neural network may be stored in the third remote device 332. Accordingly, a portion or portions of the same network may be stored in a remote device. A portion or portions of the neural network may be stored and/or operated in the cloud.

In an example, the apparatus 302, the first remote device 328, and the second remote device 330 may have less computing and/or memory resources than the third remote device 332. For instance, the apparatus 302 may be a smartphone, the first remote device 328 may be a laptop computer, the second remote device 330 may be a tablet device, and the third remote device 332 may be a desktop computer. In this example, the apparatus 302 may execute a first portion of the neural network (e.g., a CNN) that computes the features of an image (e.g., feature vector). The features may be provided to the remote devices 328, 330, 332 for further computation. The third remote device 332 may be able to execute two portions of the neural network. It may be beneficial to send a feature vector instead of the original image, in terms of the amount of data for efficient data transmission and/or in terms of protecting the original image content (e.g., user's privacy).

In some examples, tasks may be performed by remotes devices 328, 330, 332 concurrently. For instance, the first remote device 328 and the second remote device 330 may receive the first feature vector. The first remote device 328 may execute the neural network second portion instructions 320 to perform a task and the second remote device 330 may execute the neural network third portion instructions 322 to perform another task concurrently (with or without the same start and end times). The first remote device 328 may send a first result of the task to the apparatus 302 and the second remote device may send a second result of another task to the apparatus 302. For example, the first remote device 328 may send an object detection inferencing result and the second remote device 330 may send an image classification inferencing result to the apparatus 302. The apparatus 302 may store the results as results data 308.

In some examples, the apparatus 302 may present the results. For example, the apparatus 302 may present an indication of a result (e.g., text indicating an image classification, an image showing bounding boxes of detected objects, text indicating filtered emails, text indicating a transcription of audio, etc.) on a display. In some examples, the apparatus 302 may send the results to another device (e.g., server, smartphone, tablet, computer, game console, etc.).

In some approaches to inferencing, a series of inferences may be executed. For example, object detections may be performed on a video stream. In some examples, additional inferences may be triggered when an amount of change between frames is detected. This may provide power savings due to less computation, may utilize less network bandwidth, and/or may save prediction time.

The processor 304 may execute the distinctiveness determination instructions 316 to determine a distinctiveness of a second feature vector based on the first feature vector. A feature vector distinctiveness is an indication of a degree of uniqueness or difference relative to another feature vector, to a feature or features of a feature vector, and/or to a set of feature vectors. Examples of feature vector distinctiveness may include a distance between feature vectors and a change metric between features of feature vectors. In some examples, the feature vector distinctiveness determination may be performed as described in relation to FIG. 1 and/or FIG. 2. In some examples, the first feature vector may correspond to a first frame (e.g., a frame in a sequence of frames that may or may not be an initial frame). The processor 304 may determine a second feature vector corresponding to a second frame (e.g., a later frame, a next frame in a sequence, etc.) using the first portion of the neural network. In some examples, the second feature vector may be stored as feature vector data 310. The processor 304 may determine a distinctiveness of the second feature vector based on the first feature vector. The apparatus 302 (e.g., processor 304) may send the second feature vector to the selected remote device in response to determining that the second feature vector satisfies a distinctiveness criterion. A distinctiveness criterion is a criterion or criteria for determining whether a feature vector distinctiveness meets a degree of distinctiveness to send the feature vector. Examples of the distinctiveness criterion may include a distance threshold and a change criterion.

In some examples, the memory 306 may include training instructions. The processor 304 may execute the training instructions to train the neural network. For example, the first portion of the neural network may be stored as neural network first portion instructions 312. Training the neural network may include adjusting weights of the neural network. For example, the weights may be stored in the neural network first portion instructions 312.

In a training phase, for example, the neural network (e.g., the architecture of the neural network) may be trained. In some examples, the neural network (e.g., the entire neural network) may be trained by the apparatus 302. Once the neural network is trained, the apparatus 302 (e.g., processor 304) may send portions of the neural network corresponding to multiple tasks to the remote devices 328, 330, 332. In some examples, the neural network may be trained with a distributed approach. For example, the apparatus 302 (e.g., processor 304) may send untrained portions of a neural network to the remote devices 328, 330, 332. The neural network (e.g., first portion and remote portions) may be trained by coordinating training data between the apparatus 302 and the remote devices 328, 330, 332. In some examples, the neural network may be trained by a remote device or devices 328, 330, 332. When the neural network is trained, the remote device or devices 328, 330, 332 may send a first portion (e.g., joint portion, overlapping portion, etc.) of the neural network to the apparatus 302. The apparatus 302 may receive and store the first portion of the neural network (using the communication interface 324, for example). In some examples, the neural network may be pre-trained by another device, where portions of the neural network may be deployed to the apparatus 302 and the remote devices 328, 330, 332.

In some examples of training, a multi-task loss may be utilized, which may help to control what each portion of the neural network learns. In some examples, control parameters for each loss may be utilized to allow ignoring a specific loss when using a dataset that is not for a given task. For instance, when using a dataset that is for image classification purposes, a loss for object detection may not be utilized and/or considered for the loss computation.

In some examples, different portions of the neural network may be trained at different times. For instance, a trained first portion of the neural network (e.g., feature extraction portion) may be utilized in a pipeline to train another portion using the features from the trained first portion. Accordingly, a neural network portion or portions may be added over time.

In some examples, portions of the neural network may be trained concurrently or separately. For example, a first portion of the neural network, a second portion of the neural network, a third portion of the neural network, a fourth portion of the neural network, and a fifth portion of the neural network, etc., may be trained concurrently in overlapping time frames. Accordingly, an overlapping portion of the neural network and a task or tasks may be trained concurrently in some approaches. In some examples, portions of the neural network may be trained separately (e.g., in separate time frames, at different times, etc.). For example, a first portion of the neural network, a second portion of the neural network, a third portion of the neural network, a fourth portion of the neural network, and/or a fifth portion of the neural network, etc., may be trained separately in disjoint time frames. In an example, a first portion of a neural network and a second portion of the neural network may be trained concurrently, and a third portion of the neural network may be trained separately (e.g., at a later time). In some examples, additional portions (for additional tasks) of a neural network may be added over time. A neural network that is trained for multiple tasks may include portions of the neural network that are trained concurrently, and/or portions of the neural network that are trained separately (e.g., at different times). For instance, a neural network that is trained for multiple tasks may be trained in multiple training phases and/or may include portions that are trained separately. A training phase for one portion of the neural network may occur at a different time than a training phase for another portion of the neural network. In some examples, a training phase for a portion of the neural network (e.g., a task) may occur during runtime for another portion of the neural network (e.g., an overlapping portion and/or a task of the neural network). In some examples, an overlapping portion of the neural network may be trained separately (e.g., at a different time) than another portion of the neural network (for a task, for instance). For example, a first portion of the neural network (e.g., an overlapping portion) may be trained before a second portion (for a task, for instance) of the neural network.

While FIG. 3 illustrates some examples of an architecture in which some of the techniques described herein may be implemented, other architectures may be utilized. For example, different numbers of remote devices may be utilized.

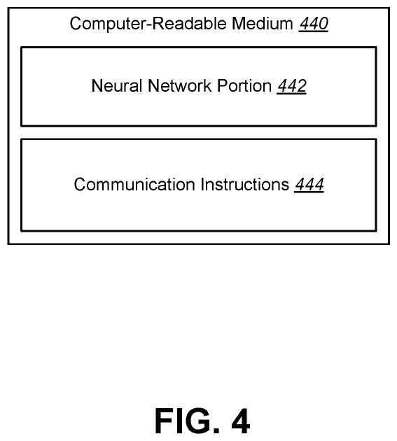

FIG. 4 is a block diagram illustrating an example of a computer-readable medium 440 for neural network execution. The computer-readable medium is a non-transitory, tangible computer-readable medium 440. The computer-readable medium 440 may be, for example, RAM, EEPROM, a storage device, an optical disc, and the like. In some examples, the computer-readable medium 440 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 440 described in connection with FIG. 4.

The computer-readable medium 440 may include code (e.g., data and/or instructions). For example, the computer-readable medium 440 may include neural network portion 442, and/or communication instructions 444.

The neural network portion 442 may include code to cause a processor to determine an inference using an exclusive portion of a neural network based on a feature vector determined by a remote device or apparatus using a shared portion of the neural network. This may be accomplished as described in connection with FIG. 1, FIG. 2, and/or FIG. 3. In some examples, the inference may be determined concurrently with another inference or inferences determined by a remote device or apparatus using another exclusive portion of the neural network.

The communication instructions 444 may include code to cause a processor to transmit the inference to the remote device or apparatus. This may be accomplished as described in connection with FIG. 1, FIG. 2, and/or FIG. 3.

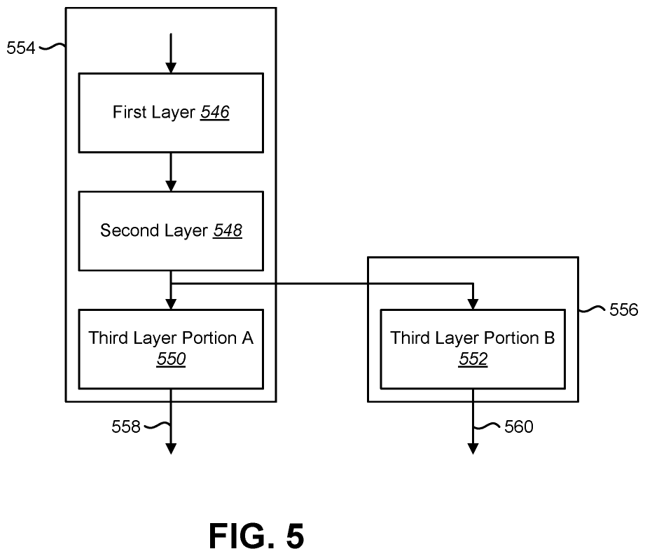

FIG. 5 is a block diagram illustrating an example of an apparatus 554 and a remote device 556 in accordance with some examples of the techniques described herein. The apparatus 554 may be an example of the apparatuses described in relation to FIGS. 1, 2, 3, and/or 4. The remote device 556 may be an example of the remote devices described in relation to FIGS. 1, 2, 3, and/or 4. In this example, the apparatus 554 includes a first layer 546, a second layer 548, and a third layer portion A 550. The remote device 556 includes a third layer portion B 552.

Some examples of the techniques described herein may include multi-tasks neural networks. A multi-task neural network is a neural network capable of performing different tasks. In some examples, a multi-task neural network may allow for the execution of multiple inferences based on the same input with fewer resources than would be utilized by multiple independent models. The multi-task neural network may be trained in a way that a portion of the neural network is shared or overlaps and other portions (e.g., branches) are utilized to specialize for each task. For instance, the first layer 546 and the second layer 548 of the neural network may be shared or overlap, while the third layer portion A 550 is exclusive to the apparatus 554 and the third layer portion B 552 is exclusive to the remote device 556. For example, the third layer portion A 550 may perform a different task from the third layer portion B 552 and may not include the same nodes. For instance, third layer portion A 550 may provide first results 558 that are different in type and/or meaning from the second results 560 provided by third layer portion B 552. Third layer portion A 550 and third layer portion B 552 may operate using the shared first layer 546 and second layer 548. For instance, third layer portion A 550 and third layer portion B 552 may use the feature vector provided by the second layer 548. Some examples of the techniques described herein may utilize a multi-task neural network to improve the execution of multiple inferences based on the same input and/or to distribute the specialized branches between multiple remote devices linked to a network or networks (e.g., the cloud).

Some benefits of some examples of the techniques described herein are given as follows. Some examples may save bandwidth by not sending original data (e.g., entire images, audio, text, etc.) to the cloud and/or by feature vectors occasionally when feature have changed by an amount. Some examples may be beneficial in privacy-sensitive scenarios, since original data (e.g., user data) may not be transmitted over the network. Some examples of the techniques described herein may cover an edge scenario, where instead of sending the feature vector to the cloud, the feature vector may be sent to different edge devices, where each edge device has a portion or portions of a neural network. Inferencing may be performed locally and/or in a distributed manner. While some of the examples describe images herein, other examples of the techniques described herein may utilized other types of data (e.g., audio, text, etc.), where processing may be split into feature extraction and classification and/or regression, etc.

Some examples of the techniques described herein may reduce a dimensionality of the input before sending it to a remote device (e.g., edge device, cloud device, etc.), which may save bandwidth due to the feature vectors being smaller than the original data (e.g., images) in some cases. In some examples, data in the form of a feature vector may not be recognizable as the raw data, which may protect user privacy. Some examples of the techniques described herein may leverage cloud parallelism and/or resources to perform inferencing for different tasks. This may be useful for scenarios where the neural network architecture includes a decoder (e.g., semantic segmentation models). Some examples of the techniques described herein may enable remote devices (e.g., edge devices) to make use of deep learning for tasks that may benefit from fast inferencing times for multiple tasks. Some of the techniques described herein may enable a convolutional neural network to execute different tasks concurrently, while sharing structure for a portion of the architecture. Some examples of the techniques described herein may enable a device or devices (e.g., edge device(s)) to execute different tasks with limited computational resources. For example, some apparatuses and/or devices may have a memory capacity that is unable to hold an entire neural network at once. In some examples, some apparatuses and/or devices may have a processing capability that is unable to perform inferencing at a frame rate of image frames or audio frames. Some of the techniques described herein may enable such resource-limited apparatuses and/or devices to be able to utilize a neural network that is larger than memory capacity (or that would occupy a more than a target proportion of memory resources) and/or that consumes a relatively large amount of processing resources. For instance, an apparatus or device may have memory capacity and/or processing resources to handle a portion of a neural network.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
determining a feature vector using a first portion of a neural network, wherein the neural network is trained for multiple tasks; and
transmitting the feature vector to a remote device, wherein the remote device is to perform one of the multiple tasks using a second portion of the neural network.

2. The method of claim 1, wherein the first portion of the neural network overlaps for each of the multiple tasks.

3. The method of claim 1, wherein the first portion of the neural network is stored in an apparatus and other portions of the neural network, respectively corresponding to each of the multiple tasks, are distributed over a set of remote devices.

4. The method of claim 1, wherein each of the multiple tasks corresponds to a mutually exclusive portion of the neural network relative to each of the other multiple tasks.

5. The method of claim 1, further comprising selecting the remote device from a set of remote devices.

6. The method of claim 1, wherein determining the feature vector comprises obscuring data input to the first portion of the neural network.

7. The method of claim 1, wherein the feature vector corresponds to first data, and wherein the method further comprises:
determining a second feature vector corresponding to second data using the first portion of the neural network; and
determining whether to transmit the second feature vector.

8. The method of claim 7, wherein determining whether to transmit the second feature vector comprises:
determining a distance between the feature vector and the second feature vector; and
comparing the distance to a distance threshold.

9. The method of claim 7, wherein determining whether to transmit the second feature vector comprises:
determining a change metric between each feature of the feature vector and a corresponding feature of the second feature vector; and
determining whether the change metric meets a change criterion.

10. The method of claim 7, wherein the first data is a first frame and the second data is a second frame in a frame sequence.

11. An apparatus, comprising:
a memory; and
a processor coupled to the memory, wherein the processor is to:
determine a first feature vector using a first portion of a neural network;
determine, from multiple tasks, a task for the first feature vector;
select a remote device corresponding to the determined task; and
send the first feature vector to the selected remote device, wherein the remote device is to perform the determined task using a second portion of the neural network.

12. The apparatus of claim 11, wherein the multiple tasks respectively correspond to remote portions of the neural network that are mutually exclusive from each other, and wherein the multiple tasks are distributed over multiple remote devices.

13. The apparatus of claim 11, wherein the first feature vector corresponds to a first frame, and wherein the processor is to:
determine a second feature vector corresponding to a second frame using the first portion of the neural network;
determine a distinctiveness of the second feature vector based on the first feature vector; and
send the second feature vector to the selected remote device in response to determining that the second feature vector satisfies a distinctiveness criterion.

14. A non-transitory tangible computer-readable medium storing executable code, comprising:
code to cause a processor to determine an inference using an exclusive portion of a neural network based on a feature vector determined by a remote apparatus using a shared portion of the neural network; and
code to cause the processor to transmit the inference to the remote apparatus.

15. The computer-readable medium of claim 14, wherein the inference is determined concurrently with a second inference determined by a remote device using a second exclusive portion of the neural network.
